(19) United States
(12) Patent Application Publication
(10) Pub. No.: US 2007/0226741 A1
(43) Pub. Date: Sep. 27, 2007

(54) POWER MANAGEMENT BASED ON DYNAMIC FREQUENCY SCALING IN COMPUTING SYSTEMS

(76) Inventor: Padmanabha Venkatagiri Seshadri, Mysore (IN)

Correspondence Address: GLOBAL IP SERVICES, PLLC, 10 CRESTWOOD LANE, NASHUA, NH, 03062, US

(21) Appl. No.: 11/277,151

(22) Filed: Mar. 22, 2006

(51) Int. Cl. G06F 9/46; G06F 1/32

(52) U.S. Cl. 718/103

(57) ABSTRACT

A novel technique for power management in computing systems and applications that significantly reduces power consumption. In one example embodiment, this is accomplished by forming a graph data structure including statistical information associated with wait state and execution paths on initiating the execution of an application program. An operating clock frequency is then computed to reach a current destination wait state as a function of the associated wait state and execution path information obtained from the formed graph data structure. The computing system is then operated at the computed operating clock frequency to reach the current destination wait state to reduce power consumption.

### TECHNICAL FIELD OF THE INVENTION

The present invention relates generally to managing power consumption in computing systems and more particularly to dynamic power management in systems and applications.

### BACKGROUND OF THE INVENTION

The dramatic increase in the performance of microprocessors in recent times has come at a premium. As the performance of microprocessors increase, they consume more power. Further as the performance of the microprocessors increase, the heat management is becoming a critical issue.

Power efficiency is a key requirement across a broad range of systems, ranging from small portable devices, to rack-mounted processor farms. Even in systems where high performance is key, power efficiency is still a care-about. Power efficiency is determined both by hardware design and component choice, and software-based runtime power management techniques.

In mobile devices, power efficiency means increased battery life, and a longer time between recharge. It also enables selection of smaller batteries, possibly a different battery technology, and a corresponding reduction in product size.

The total power consumption of a CMOS circuit is the sum of active and static power consumption. Active power consumption occurs when the circuit is active, switching from one logic state to another. Active power consumption is caused both by switching current (that needed to charge internal nodes) and through current (that which flows when both P and N-channel transistors are both momentarily on).

If an application can reduce the CPU and/or CMOS circuit clock rate and still meet its processing requirements, it can have a proportional savings in power dissipation. However, it is important to recognize that for a given task set, reducing the CPU and/or CMOS circuit clock rate also proportionally extends the execution time of the same task set, thereby affecting the performance.

There are many known techniques utilized both in hardware design and software at run-time to help reduce power dissipation. Some of the software techniques utilize dynamic frequency scaling to regulate the CPU and/or CMOS circuit clock rates so that the CPU and/or CMOS circuit operate in a low frequency/low power mode to reduce the power dissipated by the CPU and/or CMOS circuit when in the low frequency mode. Current techniques do not provide an effective way to control clock rates to reduce power consumption without compromising the performance of the computing systems and applications.

### SUMMARY OF THE INVENTION

The present subject matter provides power management based on dynamic frequency scaling. According to an aspect of the subject matter, the method includes the steps of forming a graph data structure including statistical information associated with execution paths upon executing an application program, computing an operating clock frequency to reach a current destination wait state as a function of an associated execution path obtained from the formed graph data structure, and operating the computing system at the computed operating clock frequency to reach the current destination wait state.

### BRIEF DESCRIPTION OF THE DRAWINGS

FIG. 1 is a flowchart illustrating an example technique of implementing the power management technique according to various embodiments of the present invention.

FIG. 2 is a block diagram illustrating an example graph data structure created according to an embodiment of the present invention.

FIG. 3 is a block diagram illustrating an example embodiment of initializing the graph data structure, such as those shown in FIG. 2, using two null wait states.

FIG. 4 is a block diagram illustrating an example embodiment of using the graph data structure, such as those shown in FIG. 2, for scheduling processes in a CPU.

FIG. 5 is a block diagram of a typical computer system used for implementing embodiments of the present subject matter shown in FIGS. 1-4.

### DETAILED DESCRIPTION OF THE INVENTION

In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

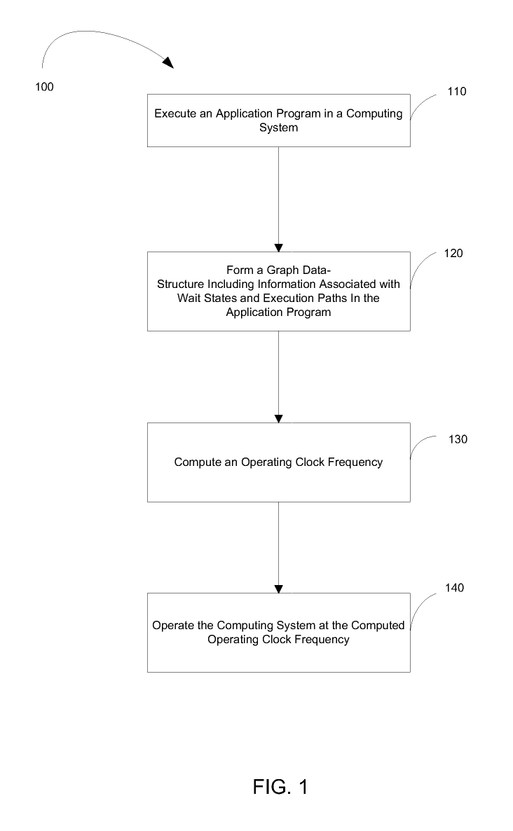

FIG. 1 is a flowchart illustrating an example embodiment of a method 100 of implementing the power management in a computing system according to the various embodiments of the present invention. At 110, the method 100 in this example embodiment executes an application program in the computing system.

At 120, a graph data structure is formed upon execution of the application program. In this example embodiment, the graph data structure includes statistical information obtained by mapping the entire process. This map can exist across all instances of an application program except in the instances when it is being created for the first time. For example, for every new execution, the graph data structure can be either used or updated as necessary during the execution of the application program. In these embodiments, the obtained statistical information is associated with the wait states and execution times. In some embodiments, the statistical information includes data, such as wait times and execution times. Further in these embodiments, the data associated with the wait states and execution paths include information, such as loops, branches, repetitions, and the like.

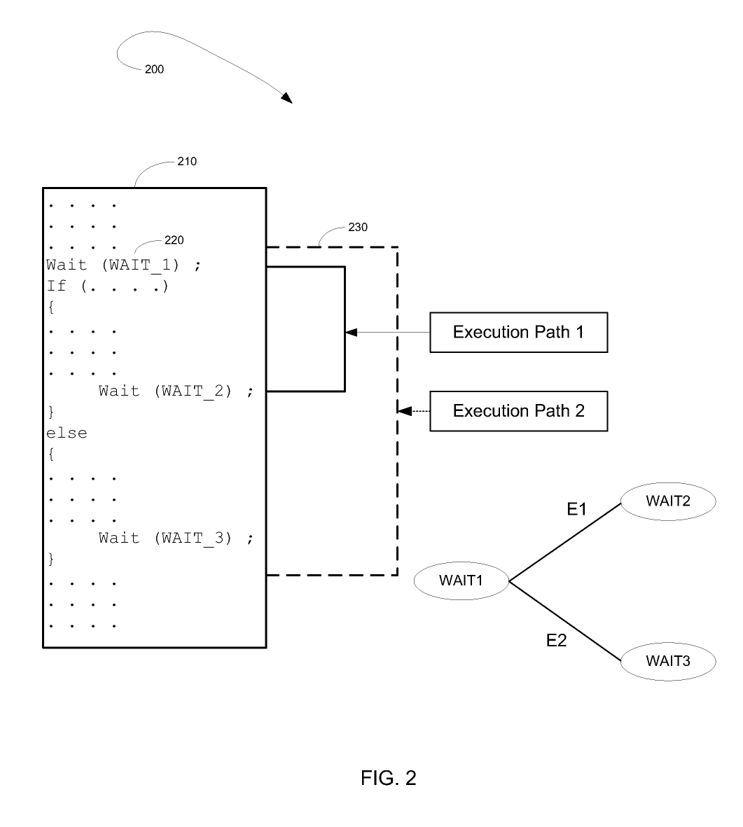

Referring now to FIG. 2, there is shown a block diagram 200 including an example graph data structure 210 that is formed according to an embodiment of the invention. As shown in FIG. 2, the graph data structure 210 includes vertices 220 and edges 230. The vertices 220 in the graph data structure 210 represent wait states. The wait states can be indexed using unique identifications (ids). The user can supply the unique ids, as a parameter to wait APIs (Application Program Interfaces). This index can be used to identify the vertices and associate them with the wait states. As shown in FIG. 2, the edges 230 connecting the vertices 220 represent the execution paths between two wait states. The edges 230 can be weighted by the time taken to traverse the associated execution paths. As shown in FIG. 2, each edge is associated with a data set of substantially previous execution times.

Further as shown in FIG. 2, the two execution paths Execution path 1 (E1) and Execution path 2 (E2), i.e., the paths going from wait state 1 (WAIT 1) to wait state 2 (WAIT 2) and WAIT 1 to wait state 3 (WAIT 3). It can be seen from FIG. 2, that the graph data structure 210 can grow dynamically during the execution of the application program, i.e., the vertices 220 and edges 230 are added to the graph data structure 210 during the execution of the process. It can be envisioned that the graph data structure 210 need not be complete upon completion of the execution of the application program as the process used may not traverse every possible execution path. This is illustrated using the following example code fragment that can be used as part of a process:

```
Time=get_time ( );
If (Time == 1700)
{
    ....
    ....
    Wait (WAIT_1);
}
Else
{
    ....
    ...
  Wait (WAIT_2);
}
```

In the get time 0 is a wait state that reads the time from a standard input stream. The above if statement is executed only if the Time variable equates to 1700. Otherwise, the above Else statement is executed. Hence, there is a good chance that execution path between get_time( ) and WAIT_1 will not be added to the graph data structure 210. However, the formed graph data structure can be re-used across various instances of the program. Hence, for every new instance, the graph data structure can grow dynamically and a more detailed map is created.

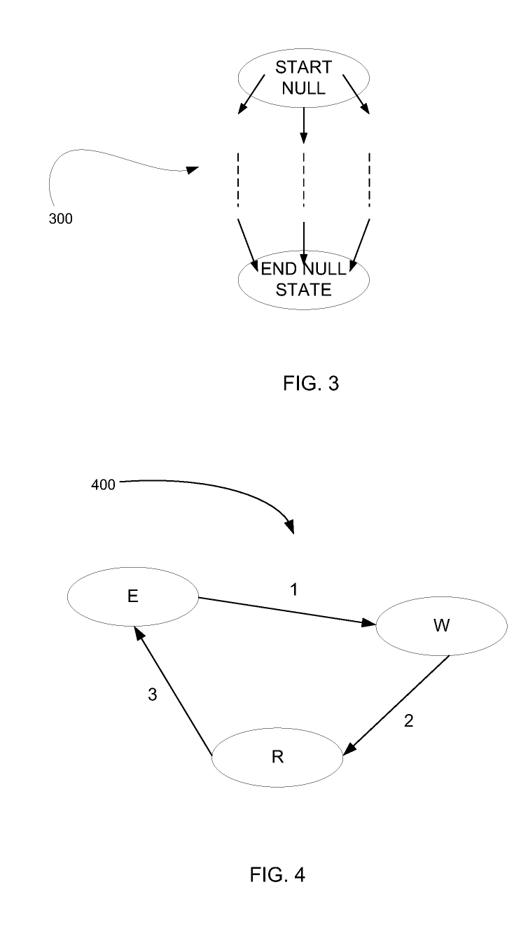

Initially, the graph data structure 210 is initialized with two NULL wait states. They are termed as NULL wait states because their wait time is generally zero. In these embodiments, the first NULL wait state acts as the starting wait state and the second NULL wait state acts as the end wait state for the process. FIG. 3 is a block diagram 300 illustrating initialized start and end NULL wait states. In these embodiments, the process can include only a computational load, which can result in only one edge from the start to end NULL wait states.

A timer procedure is generally required for the following two reasons:
1. To maintain the execution time between two wait states
2. To measure the wait time at each wait state

In these embodiments, the first step of the algorithm can include either one of the below outlined two scenarios.

Initialization when the Graph Data Structure does not Exist for a Process (Instance of the Application Program)

This scenario occurs when the process is instantiated for the first time for a given program. In such a case, a new graph data structure is created on which the process can extend.

In these embodiments, the following steps are performed:
a) A graph is created with Nₛ and Nₜ, wherein Nₛ is vertex associated with a start NULL wait state, and Nₜ is a vertex associated with the end NULL wait state.
b) Pₛ is set to point to Nₛ, wherein Pₛ is a pointer to source vertex.
c) P_{pd} is set to NULL wait state as there are no destination wait states in the edge list for Nₛ, wherein P_{pd} is the pointer to predicted destination vertex
d) F_{c} is set to Fᵣ as the edge list of Nₛ is empty and no frequency prediction is made in this step, wherein F_{c} is current frequency and Fr is the reference frequency of the CPU clock.

Initialization when the Graph Data Structure Exists for a Process

This scenario can occur when the graph is already created for a given process. The following steps are performed in this case:
a) Pₛ is set to point to Nₛ.
b) V_{pd} is predicted using an edge prediction policy and P_{pd} is set to point to V_{pd}, wherein V_{pd} is a predicted destination vertex.
c) Tₚₑ is predicted for the chosen edge using the strategy to determine execution time, wherein Tₚₑ is a predicted execution time.
d) T_{pw} is predicted for V_{pd} using the strategy to determine the wait time, wherein T_{pw} is a predicted wait time.
e) Using Tₚₑ and T_{pw}, F_{c} is computed using a frequency computation strategy, wherein F_{c} is a current frequency.

After completing the above initialization, the execution of the process can begin as outlined below:

1. During the execution of the process, the timer maintains the time elapsed between two wait states. It is initiated when the execution exits the source wait state and terminates when the execution reaches the destination wait state. For example, it acts like a stop-clock used in sprint race.

2. When execution control reaches V_{ad}, the following steps are performed:

a) A check is made on whether V_{ad} is already present in the edge-list of Pₛ.

b) If V_{ad} does not exist in the edge-list, then, a new vertex is created with the label of V_{ad} and is added to the edge-list of Pₛ. This signifies the presence of an edge from Vₛ to V_{ad}, wherein V_{ad} is the actual destination wait state.

c) Tₐₑ is normalized to Fᵣ and added to the data-set associated with previously traversed edge, wherein Tₐₑ is actual execution time. This edge can be determined by the (Vₛ, V_{ad}) pair in the edge-list of Vₛ, wherein Vₛ is source vertex and V_{ad} is actual destination vertex. The normalization is done using the following equation:
Tₙ=Tₐₑ*(F_{c}/Fᵣ)

Wherein Tₙ is normalized execution time value. In these embodiments, The execution time values are normalized to reference frequency as the execution time values are obtained when the CPU was operating at different frequencies.

d) The timer is initiated to keep track of the time for which the process blocks at this wait state

e) After the process unblocks, the timer is terminated and the wait time T_{aw} is added to the data set associated with the wait state, wherein T_{aw} is an actual wait time.

f) Vₛ is set to V_{ad} and the above steps are performed.

3. The above steps are repeated until the process terminates. At the end of the process, Nₜ is added to the edge list of Vₛ (because it can be the last wait state in the graph data structure 210); wherein Nₜ is vertex associated with terminating NULL wait state. However, in any future process instance, if there is any wait state beyond Vₛ, then Nₜ is removed from edge-list of Vₛ and added to that wait state's edge list.

The following describes the techniques used in the above-described algorithm to compute the wait times for associated wait states:

As described-above, when a wait state is encountered, the block time is recorded in a data-set associated with the wait state. This data set is later used as statistical data for wait time computation. The following describes the process used to overcome the number of values that can be stored in the data set.

The data-set size is set to a fixed value N. The number of elements is designed to not exceed the fixed value N in the data set to overcome the above limitation. The value of N set is such that the number of elements in the data set is sufficient to a prediction.
1. Each time a wait state value is added to the data set, a check is made on whether the data-set is full. If not, the running average (M) of existing values and the new value is taken and used as the predicted wait time value. The formula used is as follows:

$$Mean ( M ) = \frac{{\sum }_{i = 0}^{m} {w}_{i}}{m}$$

Wherein, m<=N.
2. If the data set is full, the following steps are performed:
   a) Running average (M) of the values is taken using the above mentioned formula
   b) The standard deviation (S) is computed using the following formula:

The above formula can be used in computing standard deviation in constant time i.e. O(1).
This can be realized as follows:
   1. Two variables are maintained. The first one is a counter for sum of the squares of the value and the second one is the sum of the values.
   2. Every time a new value is added to the data set, the above two variables are updated.
   3. During the computation of the standard deviation the sum of the squares and the sum of the values are substituted in the above formula. This will avoid iterating through each value in the data set.
c) The intervals M+S and M−S are computed.
d) All the values in the data set which fall outside the above-mentioned interval are discarded.
e) Running average (Mₙ) of the remaining values is computed and used as the predicted wait time value.

The following outlines the edge selection policy that is used in the above-described algorithm to select the destination wait state.

Generally, in loops, the same execution path is retraced and the hit-to-miss ratio is more, if the most recently used edge policy is used. The following example code illustrates the policy's effectiveness.

```
for (int I = 0 ; I <= n ; I++)
{
  ...
  ...
  Wait (WAIT_1);
  ....
  ....
}
WAIT (WAIT_2);
```

It can be seen that the for statement used in the above example code fragment is executed n times during a process. In the above example code, there are two possible execution paths.
1. From WAIT_1 to itself (Self-loop)
2. From WAIT_1 to WAIT_2

Since, the loop in the above example code executes n times, if the self-loop edge is chosen for the first time, the self-edge can remain the most recently used edge for all the n times. Hence, the hit count can be n out of n+1 choices. The only time there can be a miss is when the control exits the loop. This can happen only once.

The following outlines the execution time prediction used in the above-described algorithm.

In these embodiments, the edge selection policy chooses the edge. The next step in the edge selection is to predict the execution time along that edge. Generally, each edge is associated with a data-set (similarly to the wait state). Hence, the strategy used for predicting the wait time can be used for predicting the execution time also. In such a situation, the predicted execution time value can be the duration for traversal of the edge at a reference frequency.

In some embodiments, the graph data structure is formed by choosing the current destination wait state for a program execution upon leaving a current wait state. An execution path is then chosen to reach the chosen current destination wait state. In some embodiments, the execution path is chosen using a most-recently-used edge selection policy. The destination wait state is the wait state, which forms an edge with the source vertex, corresponding to the chosen execution path. The wait time and the execution time are then computed based on the chosen current destination wait state and the execution path. The formed graph data structure is then updated using actual wait time and the execution time associated with the chosen destination wait state and the execution path. The above process is repeated for subsequent wait states until the execution of the code ends.

At step 130, an operating clock frequency to reach a current destination wait state is computed using the computed associated wait time and execution time. The operating clock frequency is then used to set the execution frequency for the current execution path to reach the current destination wait state.

In some embodiments, the above-described process uses the following formula to compute the operating frequency for traversal along the chosen edge:

If T time is taken to traverse edge at operating frequency of Fᵣ, then, T+W time is taken to traverse edge at operating frequency of X. Since, time inversely varies with frequency,
T/X=(T+W)/Fᵣ
X=(T/(T+W))*Fᵣ
X=(1/(1+(W/T))*Fᵣ
Let, M=(W/T)
X=(1/(1+M))*Fᵣ

At step 140, the computing system is operated at the computed operating clock frequency to reach the current destination wait state.

Example details of order of execution time complexity are outlined below for each operation involved in the algorithm:

1. Insertion of Vertex and Edge in the Graph

The insertion of a vertex and edge is a constant time operation i.e. O(1)operation. This is because,
a. A pointer to the source vertex is generally maintained
b. The new edge is added to the source vertex's edge-list at the end of the list. Given that the edge list is maintained as an array and the number of edges in the edge list is available, this will be a constant time operation.
c. The vertex is added to the vertex list of the graph which is again maintained as an array. Since this is similar to the case of the edge list mentioned above, adding a vertex is a constant time operation.

2. Traversal of the Graph

We know that, the vertices of the graph are maintained in a vertex list (array). The indices identifying the wait states are used to index this array. Hence hopping from one vertex to another is a constant time operation i.e. O(1). The traversal of the graph data structure happens vertex to vertex, starting from the NULL wait state in the beginning to the NULL wait state at the end of the graph data structure.

Hence, this is also a constant time operation.

3. Predicting the Wait Time

Although, computing the mean and the standard deviation is a constant time operation, the elimination of values in the data set outside the computed range, is 0(n), where n is the size of the data set.

4. Predicting the Execution Time

In these embodiments, there are generally two operations involved in the prediction of execution time:
a. Selection of the appropriate edge
   The most recently used edge selection policy is used to choose an edge for execution. An edge is marked the recent edge at the destination vertex. This is done by matching the predicted edge (in the source vertex) with the traversed edge. Hence, this is an O(1) operation.
b. Prediction of the execution time
   This operation is similar to wait time prediction, which is an O(n) operation.

5. Predicting the CPU Frequency

From the discussion related to CPU frequency prediction be inferred that it is a mathematical computation and does not involve any traversal operations. Hence, it is an O(1) operation. Therefore, the overall time complexity of the algorithm is O(n).

In some embodiments, the memory requirements of the algorithm depend on the number of vertices m and the number of edges e present in the graph data-structure.

Hence, the total memory required can be of the O(m*e).

In some embodiments, the following formula can be used to provide an estimate of the net power saving:

Wherein, m is the number of wait states and nᵢ is the number of edges in the edge list of wait state i, Pᵣ is the power consumed by the processor when the operating frequency is Fᵣ, and Pᵢⱼ is the power consumed by the processor when the operating frequency was some Fᵢⱼ(<=Fᵣ).

The above formula gives the summation of the net power saved in one traversal, for all the edges mapped in the graph data structure. In these embodiments, the net power saved for each edge can be computed by taking the difference of the power consumed by an execution path when the frequency if Fr and the power consumed by it when the operating frequency is predicted by the algorithm.

For simplicity, ignoring the power saved in each traversal of the edge it can be observed that since Fᵣ>=Fₚ, wherein Fₚ is the predicted frequency, the power consumed for each edge Pᵢⱼ<=Pᵣ (Frequency F varies inversely with power consumed, P). Hence, the net power saving can be always be zero or greater.

Although the method 100 includes acts 110-140 that are arranged serially in the exemplary embodiments, other embodiments of the present subject matter may execute two or more acts in parallel, using multiple processors or a single processor organized into two or more virtual machines or sub-processors. Moreover, still other embodiments may implement the acts as two or more specific interconnected hardware modules with related control and data signals communicated between and through the modules, or as portions of an application-specific integrated circuit. Thus, the exemplary process flow diagrams are applicable to software, firmware, and/or hardware implementations.

Various embodiments of the present invention can be implemented in software, which may be run in the environment shown in FIG. 5 (to be described below) or in any other suitable computing environment. The embodiments of the present invention are operable in a number of general-purpose or special-purpose computing environments. Some computing environments include personal computers, general-purpose computers, server computers, hand-held devices (including, but not limited to, telephones and personal digital assistants of all types), laptop devices, multi-processors, microprocessors, set-top boxes, programmable consumer electronics, network computers, minicomputers, mainframe computers, distributed computing environments and the like to execute code stored on a computer-readable medium. The embodiments of the present invention may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices. FIG. 5 shows an example of a suitable computing system environment for implementing embodiments of the present invention. FIG. 5 and the following discussion are intended to provide a brief, general description of a suitable computing environment in which certain embodiments of the inventive concepts contained herein may be implemented.

A general computing device, in the form of a computer 510, may include a processing unit 502, memory 504, removable storage 501, and non-removable storage 514. Computer 510 additionally includes a bus 505 and a network interface (NI) 512.

Computer 510 may include or have access to a computing environment that includes one or more input devices 516, one or more output devices 518, and one or more communication connections 520 such as a network interface card or a USB connection. The computer 510 may operate in a networked environment using the communication connection 520 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 504 may include volatile memory 506 and non-volatile memory 508. A variety of computer-readable media may be stored in and accessed from the memory elements of computer 510, such as volatile memory 506 and non-volatile memory 508, removable storage 501 and non-removable storage 514. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like; chemical storage; biological storage; and other types of data storage.

“Processor” or “processing unit,” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present invention may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processing unit 502 of the computer 510. For example, a computer program 525 may comprise machine-readable instructions capable of power management in the computing system according to the teachings and herein described embodiments of the present invention. In one embodiment, the computer program 525 may be included on a CD-ROM and loaded from the CD-ROM to a hard drive in non-volatile memory 508. The machine-readable instructions cause the computer 510 to encode an audio signal on a band-by-band basis by shaping quantization noise in each band using its local gain according to some embodiments of the present invention.

The operation of the computer system 500 for power management is explained in more detail with reference to FIGS. 1-3.

The above-described technique provides a reduction in power consumption in computing systems. This process can be also be used in scheduling processes for CPU, page fault prediction and such applications related operating system processes.

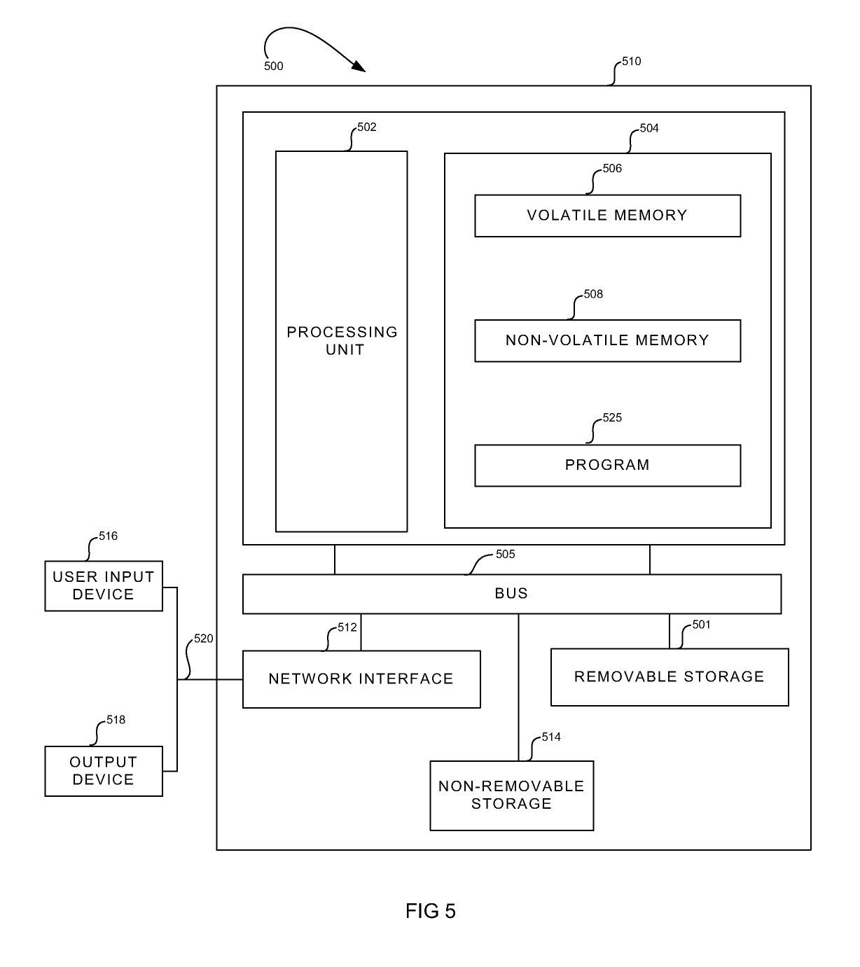

Referring now to FIG. 4, the block diagram 400 illustrates an example state machine for CPU scheduling using the above-described process. The block diagram 400 shows E, which is the execution state, W is the wait state, and R is the ready state. The transition (1) from E to W happens when a wait state is encountered during execution of the process. The graph data structure maps this wait state. The transition (2) from W to R happens when a process blocked in a wait state is un-blocked. As shown in FIG. 4, it can be added to the ready queue. Then, the transition (3) from R to E indicates the selection of a process for execution.

Further, the above process as described-above can be used to predict occurrences of page boundaries at different stages of execution of the process. For example, this can be realized by maintaining the history of page-fault occurrences between two wait states. Using this information, the page daemon can make better decisions while allocating and de-allocating pages. This can also help in using the above technique to prioritize the processes in a scheduled set.

The above technique can be implemented using an apparatus controlled by a processor where the processor is provided with instructions in the form of a computer program constituting an aspect of the above technique. Such a computer program may be stored in storage medium as computer readable instructions so that the storage medium constitutes a further aspect of the present subject matter.

The above description is intended to be illustrative, and not restrictive. Many other embodiments will be apparent to those skilled in the art. The scope of the subject matter should therefore be determined by the appended claims, along with the full scope of equivalents to which such claims are entitled.

As shown herein, the present subject matter can be implemented in a number of different embodiments, including various methods, a circuit, an I/O device, a system, and an article comprising a machine-accessible medium having associated instructions.

Other embodiments will be readily apparent to those of ordinary skill in the art. The elements, algorithms, and sequence of operations can all be varied to suit particular requirements. The operations described-above with respect to the method illustrated in FIG. 1 can be performed in a different order from those shown and described herein.

FIGS. 1-5 are merely representational and are not drawn to scale. Certain proportions thereof may be exaggerated, while others may be minimized. FIGS. 1-5 illustrate various embodiments of the subject matter that can be understood and appropriately carried out by those of ordinary skill in the art.

In the foregoing detailed description of the embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive invention lies in less than all features of a single disclosed embodiment. Thus the following claims are hereby incorporated into the detailed description of the embodiments of the invention, with each claim standing on its own as a separate preferred embodiment.

1. A method for dynamically managing power consumption in a computing system comprising:
forming a graph data structure including statistical information associated with wait states and execution paths upon executing an application program;
computing an operating clock frequency to reach a current destination wait state as a function of an associated wait state and execution path obtained from the formed graph data structure; and
operating the computing system at the computed operating clock frequency to reach the current destination wait state.

2. The method of claim 1, wherein the statistical information associated with the wait states and execution paths comprises data selected from the group consisting of wait times and execution times.

3. The method of claim 2, wherein data associated with the wait states and execution paths is selected from the group consisting of loops, branches, and repetitions in execution paths.

4. The method of claim 2, wherein forming the graph data structure comprises:
choosing the current destination wait state for a program execution upon leaving a current wait state;
choosing an execution path to reach the chosen current destination wait state;
computing the wait time and the execution time based on the chosen destination wait state and the execution path;
updating the formed graph data structure using an actual wait time and the execution time associated with the chosen current destination wait state and the execution path upon reaching the destination wait state; and
repeating the above steps of choosing the destination wait state, choosing the execution path and computing for subsequent wait states.

5. The method of claim 4, wherein the graph data structure comprises:
vertices, wherein the vertices are represented by wait states, and wherein the wait states are indexed using associated unique ids; and
vertex, wherein the vertex includes associated wait times.

6. The method of claim 1, further comprising:
repeating the steps of forming, computing and operating for a next destination wait state.

7. The method of claim 1, further comprising:
initializing the graph data structure upon starting the execution of the application program.

8. An article comprising:
a storage medium having instructions that, when executed by a computing platform, result in execution of a method comprising:
forming a graph data structure including statistical information associated with wait states and execution paths upon executing an application program;
computing an operating clock frequency to reach a current destination wait state as a function of an associated with wait state and execution path obtained from the formed graph data structure; and
operating the computing system at the computed operating clock frequency to reach the current destination wait state.

9. The article of claim 8, wherein the statistical information associated with the wait states and execution paths comprises data selected from the group consisting of wait times and execution times.

10. The article of claim 9, wherein data associated with the wait states and execution paths is selected from the group consisting of loops, branches, and repetitions in execution paths.

11. The article of claim 9, wherein forming the graph data structure comprises:
choosing the current destination wait state for a program execution upon leaving a current wait state;
choosing an execution path to reach the chosen current destination wait state;
computing the wait time and the execution time based on the chosen destination wait state and the execution path;
updating the formed graph data structure using an actual wait time and the execution time associated with the chosen current destination wait state and the execution path upon reaching the destination wait state; and
repeating the above steps of choosing the destination wait state, choosing the execution path and computing for subsequent wait states.

12. The article of claim 11, wherein the graph data structure comprises:
vertices, wherein the vertices are represented by wait states, and wherein the wait states are indexed using associated unique ids; and
vertex, wherein the vertex includes associated wait times.

13. The article of claim 8, further comprising:
repeating the steps of forming, computing and operating for a next destination wait state.

14. The article of claim 8, further comprising:
initializing the graph data structure upon starting the execution of the application program.

15. A computer system comprising:
a processor; and
a memory coupled to the processor, the memory having stored therein code which when decoded by the processor, the code causes the processor to perform a method comprising:
forming a graph data structure including statistical information associated with wait states and execution paths on initiating an application program;
computing an operating clock frequency to reach a current destination wait state as a function of an associated wait state and execution path obtained from the formed graph data structure; and
operating the computing system at the computed operating clock frequency to reach the current destination wait state.

16. The system of claim 15, wherein the statistical information associated with the wait states and execution paths comprises data selected from the group consisting of wait times and execution times.

17. The system of claim 16, wherein data associated with the wait states and execution paths is selected from the group consisting of loops, branches, and repetitions in execution paths.

18. The system of claim 16, wherein forming the graph data structure comprises:
choosing the current destination wait state for a program execution upon leaving a current wait state;
choosing an execution path to reach the chosen current destination wait state;
computing the wait time and the execution time based on the chosen destination wait state and the execution path;
updating the formed graph data structure using an actual wait time and the execution time associated with the chosen current destination wait state and the execution path upon reaching the destination wait state; and
repeating the above steps of choosing the destination wait state, choosing the execution path and computing for subsequent wait states.

19. The system of claim 18, wherein the graph data structure comprises:
vertices, wherein the vertices are represented by wait states, and wherein the wait states are indexed using associated unique ids; and
vertex, wherein the vertex includes associated wait times.

20. The system of claim 15, further comprising:
repeating the steps of forming, computing and operating for a next destination wait state.
